(19) United States
(12) Patent Application Publication
(10) Pub. No.: US 2006/0129386 A1
(43) Pub. Date: Jun. 15, 2006

(54) METHOD AND APPARATUS FOR SPEECH CONTROL

(76) Inventors: Yuan-Chia Lu, Hualien County (TW); Jia-Lin Shen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,718

(22) Filed: Oct. 28, 2005

(30) Foreign Application Priority Data
Dec. 15, 2004 (TW) 93138875

(51) Int. Cl. G10L 11/00

(52) U.S. Cl. 704/200

(57) ABSTRACT

A method and apparatus for speech control is provided. The apparatus includes a speech receiver, a speech recognition engine, and an automatic regulation device. In the method, first, a speech is received. Then the speech is identified to obtain an operating order which is to adjust the quantification set with graduation. The machine's quantification set is automatically regulated by means of the operating order. Last, the regulation of the said quantification set is stopped.

### CROSS-REFERENCE TO RELATED APPLICATION

This application claims the priority benefit of Taiwan application serial no. 93138875, filed Dec. 15, 2004. All disclosure of the Taiwan application is incorporated herein by reference.

### BACKGROUND OF THE INVENTION

1. Field of Invention

The present invention relates to a remote control method and apparatus. More particularly, the present invention relates to a method and apparatus for speech remote control which can automatically adjust the quantification set.

2. Description of Related Art

Speech and language are human native abilities. Communication is further the best way for people to exchange messages. Because everybody has the ability of speech, it is expected that people can directly order machines with speech, even exchange information with machines, in order to simplify the complicated operations.

Remote controllers are invented for people to operate machines conveniently, which makes it possible for people to operate machines in remote other than rush to the machines from far. In daily life, video apparatus, for example TV sets, are machines ordinarily using remote controllers. For turning a TV set on, a user dose not need to run to front of it to press the ON button, but just takes up the TV remote controller at hand and presses the ON button on it. Further more, the user can use a number of control buttons on the TV remote controllers to control the channels, volume, contrast and brightness settings and other function settings of TV sets.

FIG. 1 is a flow chart of the traditional remote control method. The traditional remote control method is illustrated with the example of adjusting the sound volume of a video apparatus. First, at the step S101, when a button on the remote controller is pressed, the remote controller issues a remote control signal in accordance with the button to set the sound volume. For example, the button increasing the sound volume is pressed to increase the sound volume of the video apparatus. Then, at the step S103, the video apparatus receives the remote control signal issued by the remote controller and identifies the order to determine the corresponding action. At the step S105, the video apparatus performs the identified action. Last, the action of the remote control is stopped at the step S107.

At present, the interface being used most often is On Screen Display (OSD) which can display relative settings screen by screen and whose functions are more than that of previous list interface. Through the OSD interface, with only a few buttons, the various settings, for example, the screen brightness and contrast, vertical and horizontal width and level, can be adjusted. Therefore, most manufacturers use this interface. However, a user has to press UP, DOWN and OK buttons first to enter relative options, afterwards, continuously press the setting buttons to adjust the graduations, or use UP and Down buttons again to select the needed settings.

The traditional remote control method, with which a user has to find the remote apparatus first and take it up, then seek wanted button on it and press the button, looks harder to use than the speech remote control. Besides, when a setting with quantification set with graduation, e.g. level and size, needs to be changed, for example, the sound volume of TV set, the control button of the remote controller has to be pressed continuously until the requirement of the user is met. Such an operating interface is not very humanized.

### SUMMARY OF THE INVENTION

Accordingly, the present invention is directed to provide a speech remote control method and apparatus to reach the goal of improving the humanization of operating interface and adjusting quantification set with graduation automatically with the way of speech remote control.

The present invention provides a speech remote control method and apparatus. First, a speech is received. Then the speech is identified to obtain an operating order which is to adjust the quantification set with graduation. The said quantification set is automatically regulated. Last, the regulation of the said quantification set is stopped to finish the remote control setting.

According to the speech remote control method of the preferred embodiment of the present invention, the steps of adjusting aforementioned quantification set are: automatically increasing/decreasing the graduation of aforementioned quantification set every other moment, and the rate of the automatic increase/decrease of the graduation of the quantification set is adjustable.

According to the speech remote control method of the preferred embodiment of the present invention, the steps of automatically stopping the automatic regulation of the aforementioned quantification set are: receiving stop speech, then, identifying the aforementioned stop speech to obtain the stop operating order, last, stopping the automatic regulation of the quantification set.

According to the speech remote control method of the preferred embodiment of the present invention, the steps of stopping the automatic regulation of the aforementioned quantification set can also be: pressing the stop button of the remote controller, then, the remote controller issuing the corresponding stop signal according to the aforementioned stop button, last, receiving aforementioned stop signal to stop the automatic regulation of the quantification set.

The present invention provides another speech remote control method. First, a speech is received. Then the speech is identified to obtain an operating order which is a selective option setting with multiple adjusting options. The multiple adjusting options of the selective option setting display periodically in order to be selected. Last, one of the above adjusting options is selected.

The speech remote control apparatus according to the preferred embodiment of the present invention includes a speech receiver, a speech recognition engine and an automatic regulation device. The speech receiver is used to receive a speech. The speech recognition engine is used to identify the speech to obtain an operating order which is to adjust a quantification set with graduation. The automatic regulation device is used to control the start and the stop of the automatic regulation of the quantification set. The steps of the automatic regulation of the quantification set of the remote control apparatus can be automatically increasing the graduation of the quantification set every other moment, or automatically adjusting the rate of the graduation of the quantification set, or automatically decreasing the graduation of the quantification set every other moment, and so on.

The mode for the automatic regulation device to stop the automatic regulation of quantification set includes, in one of the selective embodiment, receiving a stop speech through the speech receiver, and identifying the stop speech through the speech recognition engine to obtain a stop operating order, then stopping the automatic regulation of the quantification set according to the stop operating order. In another selective embodiment, the mode can be pressing a stop button on the remote control device so as to issue a corresponding stop signal to stop the automatic regulation of the quantification set.

Because of using speech for remotely controlling the setting options, the present invention greatly increases the humanization and convenience of the operating interface. Further more, the present invention can automatically regulate the graduation of quantification set and stop the automatic regulation when the user thinks the right graduation has been reached, so that a disadvantage of the traditional method that a button has to be pressed continuously to adjust a setting can be got rid of.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a flow chart of the traditional remote control method.

FIG. 2 is a flow chart illustrating the speech remote control method according to a preferred embodiment of the present invention.

FIG. 3 is a flow chart illustrating the speech remote control method of another preferred embodiment of the present invention.

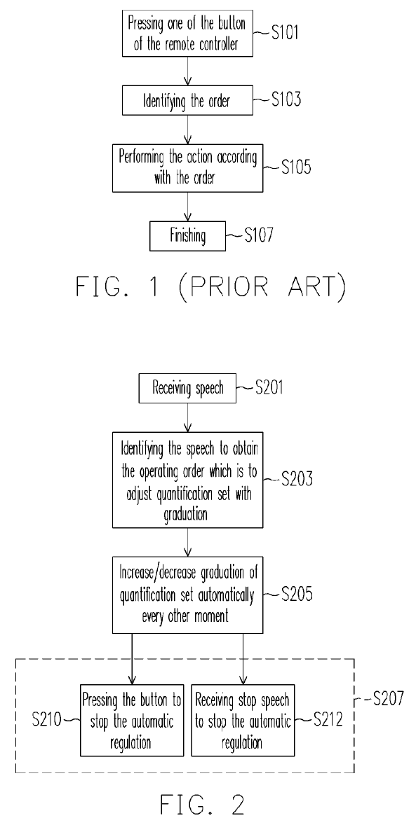

### DESCRIPTION OF EMBODIMENTS

Because of using speech as the way of remote control, the present invention can increase the humanization of operating interface. Here video apparatus is regarded as example. For regulating the settings, if the settings are the quantification sets e.g. sound volume and brightness which are frequently changed in video apparatus, the video apparatus can automatically increase/decrease the regulated graduations of the quantification sets, and stop the automatic regulation when the user thinks the right graduation has been reached. If the settings are selective option settings with multiple adjusting options, these options periodically display on the video apparatus for the user to select the needed option.

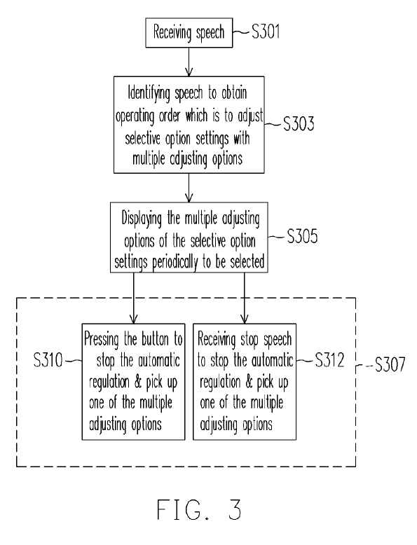

Here a number of preferred embodiments are illustrated to explain the present invention. Refer to FIG. 2 which is a flow chart illustrating the speech remote control method according to a preferred embodiment of the present invention. All the preferred embodiments of the present invention take remote control video apparatus as their applying examples, and take remote controllers as the apparatus receiving user speeches. However, to those skilled in the art, the speech receiving apparatus can be made onto the video apparatus, so it is to be understood that the embodiments is not to be taken in a limiting sense.

First, at the step S201, the remote controller receives a speech which is issued by the user for remotely controlling the video apparatus. At the step S203, the remote controller identifies the speech and obtains the operating order from the vocabulary of the speech, wherein, the order is to adjust the quantification set with graduation, for example, the settings of sound volume and brightness in the video apparatus. To those skilled in the art, the action identifying speeches can also be performed in the video apparatus after the remote controller transfers all the speeches to the video apparatus, other than the limit of the computing power of the remote controller.

At the step S205, because the operating order is to adjust quantification set with graduation, after receiving the order, the video apparatus automatically regulates the graduation of the quantification. There are two methods to be referenced for the automatic regulation of graduation in this embodiment. One of them automatically increases the graduation of the quantification set every other moment until the automatic regulation is stopped at the step S207. The other one automatically decreases the graduation of the quantification set every other moment until the automatic regulation is stopped at the step S207.

At the step S207, the automatic regulation at the step S205 is stopped through one of the two different methods listed here to be referenced in the embodiment. To those skilled in the art, it is to be understood that the embodiment is not to be taken in a limiting sense. The first method shown in the step S210 includes: pressing the stop button of the remote controller; then the remote controller issuing the corresponding stop signal to the video apparatus; the video apparatus stopping the automatic regulation of the graduation of the quantification set. The other method shown in the step S212 includes: the remote control receiving the speech and identifying the speech to obtain the stop order, the video apparatus receiving the stop signal so as to stop the automatic regulation of the graduation of the quantification set.

Wherein, the rate of the automatic increase/decrease of the graduation of the quantification set can be adjusted according to the habits of users in order to accord with the invention goal of the operating interface humanization.

If the settings to be adjusted are the selective option settings with multiple adjusting options, another speech remote control method is used. FIG. 3 is a flow chart illustrating the speech remote control method of another preferred embodiment of the present invention. Referring to FIG. 3, first, at the step S301, a remote controller receives a speech which is issued by a user for remotely controlling a video apparatus. At the step S303, the remote controller identifies the speech to obtain an operating order according to the vocabulary of the speech, wherein, the order is to adjust selective option settings with multiple adjusting options, for example, in video apparatus, the selection of multiple language interfaces and the setting of stereo are all multiple adjusting options other then graduations of quantification set. To those skilled in the art, the action of identifying speeches can also be performed in the video apparatus after the remote controller transfers all the speeches to the video apparatus, other than the limit of the computing power of remote controllers.

At the step S305, because the operating order is to adjust selective option settings with multiple adjusting options, after receiving the order, the video apparatus displays the multiple adjusting options of the selective option setting periodically for the user to look over and select.

At the step S307, one of multiple adjusting options in the step S305 is selected to finish the remote control action. Two different methods of this embodiment are given here to be referenced. To those skilled in the art, it is to be understood that the embodiment is not to be taken in a limiting sense. The first method shown in the step S310 includes: pressing the selective option button of the remote controller; then the remote controller issuing the corresponding selective option signal to the video apparatus; the video apparatus receiving the signal and pick up the selection and stop the regulation . The other method shown in the step S312 includes: the remote controller receiving a selective option speech and identifying the selective option speech to obtain a selective option order, then the video apparatus receiving the selective the signal and pick up the selection and stop the regulation.

Wherein, the rate of the periodic displays of the multiple adjusting options of the selective option setting on the video apparatus can be adjusted according to the habits of users in order to accord with the invention goal of the operating interface humanization.

The method illustrated in the aforementioned embodiment can be used for a remote control apparatus according to a preferred embodiment of the present invention. The apparatus includes a speech receiver, a speech recognition engine and an automatic regulation device. The speech receiver is used to receive a speech as shown in the step S301. The recognition engine is used to identify the speech to obtain an operating order as shown in the step S303, wherein, the order is to adjust the graduation of a quantification set. The automatic regulation device is used to control the start and the stop of the automatic regulation of the quantification set as shown in the steps S305 and S307. The steps of the automatic regulation of the quantification set of the automatic regulation device can be automatically increasing the graduation of the quantification set every other moment, or automatically adjusting the rate of the graduation of the quantification set, or automatically decreasing the graduation of the quantification set every other moment, and so on.

The mode for the automatic regulation device to stop the automatic regulation of quantification set includes, in one of the selective embodiments, receiving a stop speech through the speech receiver, and identifying the stop speech through the speech recognition engine to obtain a stop operating order, then stopping the automatic regulation of the quantification set according to the stop operating order. In another selective embodiment, the mode can be pressing a stop button on the remote control device so as to issue an corresponding stop signal to stop the automatic regulation of the quantification set.

In summary, because of using speech for remotely controlling the setting options, the present invention greatly increases the humanization and convenience of the operating interface. Further more, the present invention can automatically regulate the graduation of quantification set and stop the automatic regulation when the user thinks the right graduation has been reached, so that a disadvantage of the traditional method that the button has to be pressed continuously to adjust a setting can be got rid of.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordant with the scope of the following claims and their equivalents.

What is claimed is:

1. A speech remote control method comprises:
receiving a speech;
identifying the speech to obtain a operating order which is to adjust a quantification set with graduation;
regulating the quantification set automatically; and
stopping the automatic regulation of the quantification set.

2. The speech remote control method as claimed in claim 1, wherein, the step of the automatic regulation of the quantification set is automatically increasing the graduation of the quantification set every other moment.

3. The speech remote control method as claimed in claim 2, wherein, the rate of the automatic increase of the graduation of the quantification set is adjustable.

4. The speech remote control method as claimed in claim 1, wherein, the step of the automatic regulation of the quantification set is automatically decreasing the graduation of the quantification set every other moment.

5. The speech remote control method as claimed in claim 4, wherein, the rate of the automatic decrease of the graduation of the quantification set is adjustable.

6. The speech remote control method as claimed in claim 1, wherein, the steps of stopping the automatic regulation of the quantification set comprise:
receiving a stop speech;
identifying the stop speech to obtain a stop operating order; and
stopping the automatic regulation of the quantification set.

7. The speech remote control method as claimed in claim 1, wherein, the steps of stopping the automatic regulation of the quantification set comprise:
pressing a stop button of a remote controller;
the remote controller issuing a corresponding stop signal according to the stop button;
receiving the stop signal; and
stopping the automatic regulation of the quantification set.

8. A speech remote control method comprises:
receiving a speech;
identifying the speech to obtain an operating order which is a selective option setting with multiple adjusting options;
displaying the multiple adjusting options of the selective option setting periodically in order to be selected; and
selecting one of the adjusting options.

9. The speech remote control method as claimed in claim 8, wherein, the rate of the periodic displays of the options is adjustable.

10. The speech remote control method as claimed in claim 8, wherein, the steps selecting one of the adjusting options comprise:
receiving a selective option speech;
identifying the selective option speech to obtain a selective option order; and
selecting one of the adjusting options according to the selective option order.

11. The speech remote control method as claimed in claim 8, wherein, the steps selecting one of the adjusting options comprise:
pressing a selective option button of a remote controller;
the remote controller issuing a corresponding selective option signal according to the selective option button;
receiving the selective option signal; and
selecting one of the adjusting options according to the selective option signal.

12. A remote control apparatus comprises:
a speech receiver used to receive a speech;
a recognition engine used to identify the speech to obtain an operating order which is to adjust a quantification set with graduation; and
an automatic regulation device used to control the start and the stop of the automatic regulation of the quantification set.

13. The remote control apparatus as claimed in claim 12, wherein, the step of the automatic regulation of the quantification set is automatically increasing the graduation of the quantification set every other moment.

14. The remote control apparatus as claimed in claim 12, wherein, the rate of the automatic adjustment of the graduation of the quantification set is adjustable.

15. The remote control apparatus as claimed in claim 12, wherein, the step of the automatic regulation of the quantification set is automatically decreasing the graduation of the quantification set every other moment.

16. The remote control apparatus as claimed in claim 12, wherein, the mode for the automatic regulation device to stop the automatic regulation of the quantification set is: receiving a stop speech by means of the speech receiver, and identifying the stop speech by means of the speech recognition engine to obtain a stop operating order, then stopping the automatic regulation of the quantification set according to the stop operating order.

17. The remote control apparatus as claimed in claim 12, wherein, the mode for the automatic regulation device to stop the automatic regulation of the quantification set is: pressing a stop button on the remote control device, and issuing a corresponding stop signal to stop the automatic regulation of the quantification set.
